(19) United States
(12) Patent Application Publication
(10) Pub. No.: US 2014/0275728 A1
(43) Pub. Date: Sep. 18, 2014

(54) Wireless Microactuator

(71) Applicant: OtoKinetics Inc., (US)

(72) Inventor: Gregory N. Koskowich, Pleasanton, CA (US)

(73) Assignee: OtoKinetics Inc., Salt Lake City, UT (US)

(21) Appl. No.: 13/802,261

(22) Filed: Mar. 13, 2013

(51) Int. Cl. H04R 25/00

(52) U.S. Cl. CPC H04R 25/554
USPC 600/25

(57) ABSTRACT

According to an exemplary embodiment the hearing of a patient may be improved by providing the patient with a wearable package having a microphone, a wireless transmitter circuit responsive to the microphone to transmit a wireless transducer signal, a power storage device configured to provide power to the transmitter circuit; and a wireless power transmission circuit configured to transmit a wireless power signal and implanting into the patient an electrically powered microactuator having: a wireless receiver circuit to receive the wireless transducer signal; a transducer drive circuit coupled to the wireless receiver circuit to convert the received transducer signal into a transducer drive signal; a transducer coupled to the transducer drive circuit to convert the transducer drive signal into motion; and a wireless power reception circuit configured to receive the wireless power signal to power the transducer drive circuit.

### TECHNICAL FIELD

The present disclosure is directed generally to the field of partially and fully implantable hearing aids.

### BACKGROUND

Current Middle Ear Implant transducers and Cochlear Implant electrodes are connected to an implanted electronics module by a cable comprising one or more wires. The implanted electronics module contains a telemetry system for receiving audio communication (the signal) and a power transfer system to provide power to the transducer or electrode. The signal can be either analog or digital depending on the implementation. The signal is generated, and the power is stored, in an external electronics module, which often contains a microphone and a battery.

The cable may occasionally extrude through the skin causing infection. Implanting the entire electronics module can take a long time, may take up a lot of space, making it uncomfortable, and can lead to further complications (e.g., infection, facial paralysis, taste disturbance or loss, and allergic reaction).

Most Cochlear Implants and Middle Ear Implants use a pair of coils, one external and one implanted beneath the skin, to transmit both power and signal. The implanted coil is often located behind the ear and is covered by tissue up to 15 mm thick or more. The external coil is aligned coaxially with the implanted coil to optimize power and signal transfer. The coils are inductively coupled (using a magnetic field) and require both alignment and proximity to be maintained during operation. The external coil is often secured with magnets or adhesives, to ensure proper alignment and operation.

Cochlear Implants and Middle Ear Implants are designed to be as small as possible given the technology used. A smaller size tends to cause less surgical trauma. In addition, such implants use special coatings on the wires, leads, transducers and module casing in order to reduce infection and tissue reaction to these foreign bodies. The implants are secured with special fittings and attachments to minimize movement, thereby reducing irritation and the probability of extrusion.

### OVERVIEW

According to an exemplary embodiment the hearing of a patient may be improved by providing the patient with a wearable package having a microphone, a wireless transmitter circuit responsive to the microphone to transmit a wireless transducer signal, a power storage device configured to provide power to the transmitter circuit; and a wireless power transmission circuit configured to transmit a wireless power signal and implanting into the patient an electrically powered microactuator having: a wireless receiver circuit to receive the wireless transducer signal; a transducer drive circuit coupled to the wireless receiver circuit to convert the received transducer signal into a transducer drive signal; a transducer coupled to the transducer drive circuit to convert the transducer drive signal into motion; and a wireless power reception circuit configured to receive the wireless power signal to power the transducer drive circuit.

Using a wireless communication and power system to provide the signal and power transfer to the microactuator directly (which is implanted into the wall of the cochlea), eliminates the cable and the electronics module from the implant, reducing the surgical time, surgical risk and probability of complications after implantation. A small wireless microactuator can be implanted quickly, with a simple surgical procedure and avoids many of the complications associated with implanting a system comprised of separate transducer and module connected by a cable.

### BRIEF DESCRIPTION OF THE DRAWINGS

The accompanying drawings, which are incorporated into and constitute a part of this specification, illustrate one or more exemplary embodiments and, together with the description of the exemplary embodiments, serve to explain the principles and implementations of the invention.

In the drawings:

FIGS. 1A and 1B together form a system block diagram of a generic partially implantable hearing aid system using one or more wireless techniques to transmit audio signals and power to an implanted microactuator in accordance with an exemplary embodiment.

FIG. 2 is a system block diagram of a partially implantable hearing aid system using radio frequency (RF) energy (a form of electromagnetic energy) to transmit audio signals and power to an implanted microactuator in accordance with an exemplary embodiment.

FIG. 3 is a cross-sectional elevational diagram illustrating an implementation of an implantable microactuator in accordance with the implementation of FIG. 2 in accordance with an exemplary embodiment.

FIG. 4 is a system block diagram of a partially implantable hearing aid system using magnetic induction energy to transmit audio signals and power to an implanted microactuator in accordance with an exemplary embodiment.

FIG. 5 is a cross-sectional elevational diagram illustrating an implementation of an implantable microactuator in accordance with the implementation of FIG. 4 in accordance with an exemplary embodiment.

FIG. 6 is a system block diagram of a partially implantable hearing aid system using light (a form of electromagnetic energy) to transmit audio signals and power to an implanted microactuator in accordance with an exemplary embodiment.

FIG. 7 is a cross-sectional elevational diagram illustrating an implementation of an implantable microactuator in accordance with the implementation of FIG. 6 in accordance with an exemplary embodiment.

FIG. 8 is a system block diagram of a partially implantable hearing aid system using ultrasonic energy (a form of mechanical energy) to transmit audio signals and power to an implanted microactuator in accordance with an exemplary embodiment.

FIG. 9 is a cross-sectional elevational diagram illustrating an implementation of an implantable microactuator in accordance with the implementation of FIG. 8 in accordance with an exemplary embodiment.

FIG. 10 is a process flow diagram illustrating a method of improving patient hearing in accordance with an exemplary embodiment.

### DESCRIPTION OF EXAMPLE EMBODIMENTS

Exemplary embodiments are described herein in the context of partially and fully implantable hearing aids. Those of ordinary skill in the art will realize that the following description is illustrative only and is not intended to be in any way limiting. Other embodiments will readily suggest themselves to such skilled persons having the benefit of this disclosure. Reference will now be made in detail to implementations of the exemplary embodiments as illustrated in the accompanying drawings. The same reference indicators will be used to the extent possible throughout the drawings and the following description to refer to the same or like items.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with this disclosure, the components, process steps, and/or data structures described herein may be implemented using various types of operating systems, computing platforms, computer programs, and/or general purpose machines. In addition, those of ordinary skill in the art will recognize that devices of a less general purpose nature, such as hardwired devices, FPGAs, ASICs, or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Erasable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card, paper tape and the like) and other types of program memory.

Turning to the figures, various exemplary embodiments of hearing aids with wirelessly powered implantable microactuators and methods for their utilization are illustrated in detail.

FIGS. 1A and 1B together form a system block diagram of a generic partially implantable hearing aid system 10 using one or more wireless techniques to transmit audio signals and power to an implanted microactuator in accordance with an exemplary embodiment. System 10 comprises a wearable portion 12 and an implantable microactuator module 14. Wearable portion 12 includes an electrical power and signal source portion 13 and various components for accomplishing wireless signal and wireless energy transmission (here elements 28 and 36). Signal source portion 13 includes a microphone 16, amplifier/equalizer electronic circuitry 18 coupled to microphone 16 to condition a signal from the microphone on line 20. A signal on line 22 from circuitry 18 is applied to modulator 24 which may be of any type suitable to the application. A modulated signal is provided by modulator 24 on line 26 and delivered to wireless signal transmitter 28 from which it is wirelessly transmitted over a selected medium (e.g., electromagnetic radiation, ultrasonic radiation, magnetic induction and the like) to module 14. A power storage device 30 such as a battery or large capacitor is provided to power wearable portion 12. If a battery it may be rechargeable or non-rechargeable. An optional recharge circuit 32 may be provided to recharge a rechargeable battery over line 34 or the recharging may be done by an independent charging device. Finally a wireless energy transmitter 36 (which may be integrated with wireless signal transmitter 28 if desired) transmits energy wirelessly over a selected medium (e.g., electromagnetic radiation, ultrasonic radiation, magnetic induction and the like). Circuitry 18, modulator 24, transmitter 28 and transmitter 36 all consume electrical power and that power is supplied by power storage device 30 over power bus 38.

Module 14 is intended to be very small and easily implanted into a human patient. It includes wireless receive circuitry 40 which receives the signal from transmitter 28 and that of transmitter 36 (if separately provided) containing the audio signal ultimately sourced from microphone 16 and a power signal used to power module 14. Circuitry 40 distributes the received signal to audio signal extraction/conditioning/drive circuitry 42 (which may be integrated on a single chip to help minimize size) and to power signal extraction/conditioning circuitry 44 (which may be integrated on the same chip). Circuitry 42 extracts the audio signal from the signal received by circuitry 40 and prepares it to drive a transducer 46 (such as a piezoelectric transducer) which provides a sense of sound to the patient. A suitable transducer for this application is a thin (˜100 um thickness) piezo material (such as a PZT—lead zirconate titanate—crystal or stack of crystals of circular axial cross-section) attached on one side to a titanium diaphragm with solder. The other side has a metal layer deposited on it to make electrical contact and create the electric field needed to activate the piezo material. Circuitry 44 extracts a small amount of power from the signal received by circuitry 40 and uses it to power circuitry 42 which drives the transducer 46. It may include a small capacitor for smoothing out gaps in received power which may occur without imposing an acoustically detectable gap in the patient's hearing.

FIG. 2 is a system block diagram of a partially implantable hearing aid system 48 using radio frequency (RF) energy (a form of electromagnetic energy) to transmit audio signals and power to an implanted microactuator in accordance with an exemplary embodiment. In accordance with this exemplary embodiment wearable portion 12 transmits both its power signal and its audio signal using RF energy. In module 14 everything is housed in a unitary module with no cables extending from it. Module 14 houses the antenna 50 for receiving the RF energy as well as an integrated circuit 52 for implementing circuitry 42 and 44 and a piezoelectric transducer 46.

Using RF transmission at UHF frequencies (300 MHz and above) reduces the physical size needed for the antenna and improves the energy density of the overall system. The propagation distance could be as short as 2-3 mm if the RF transmitter is in the ear canal, or 2-3 cm if it is in the concha or behind the ear. The RF power is extracted by a conventional electrical circuit and used to provide the voltage necessary to operate the signal extraction and conditioning circuit. The output of the signal extraction and conditioning circuit drives the piezo transducer 46 at the audio frequency and power levels required to produce sound sensation in the cochlea.

FIG. 3 is a not-to-scale cross-sectional elevational diagram illustrating an implementation of module 14 in accordance with the implementation of FIG. 2 in accordance with an exemplary embodiment. In accordance with this exemplary embodiment module 14 is formed with a cylindrical titanium case 54. Titanium is selected due to its favorable biocompatible properties. A first titanium membrane 56 of thickness approximately 10-20 microns is disposed at the end intended to be disposed closest to the fluid contained in the cochlea. A fluid filled chamber 58 is disposed inwardly from membrane 56 and may be filled with a saline solution or another buffered solution compatible with perilymph. A second titanium membrane 60 of thickness approximately 30 microns seals chamber 58. A piezoelectric material 62 is disposed on a side of second titanium membrane 60 opposite chamber 58. A radial gap 64 is provided between case 54 and piezoelectric material 62 to minimize interaction between the piezoelectric material and case 54 and allow the titanium membrane 60 to flex under stress. An insulator structure 66 is provided to seal the case 54. The insulator may be a ceramic material. On the inward side of the insulator is disposed an integrated circuit 52 containing the circuitry described above. Electrical connections 68 are provided to connect the integrated circuit 52 to the piezoelectric material 62. One or more feedthroughs 70 are provided in structure 66 to provide an electrical connection to an RF receive antenna 72 patterned on a ceramic wafer 74. The device is finally sealed with a parylene, polyimide or silicone encapsulant 76 (or a similar biocompatible material).

FIG. 4 is a system block diagram of a partially implantable hearing aid system 78 using magnetic induction energy to transmit audio signals and power to an implanted microactuator in accordance with an exemplary embodiment. In accordance with this exemplary embodiment wearable portion 12 transmits both its power signal and its audio signal using magnetic induction energy via an electromagnet 80 (magnetic core (e.g., Iron or Nickel or Alnico) with a coil wound around it). In module 14 everything is housed in a unitary module with no cables extending from it. Module 14 houses an electromagnet 82 used for receiving a magnetic induction signal from electromagnet 80. In this embodiment a simple electrical matching circuit 84 may be used to convert the magnetic signal into a voltage for driving piezoelectric transducer 46.

Using magnetic coupling between two coils, one in the ear canal and one contained in the microactuator assembly, allows both signal and power to be transmitted over the very short distance between them (2-3 mm) with a simple electro-magnetic circuit. A “driver” coil is energized by an audio frequency electrical signal generator, creating a magnetic field that is coupled to the “receiving” coil. The magnetic field in the receiving coil produces a voltage and provides both power and signal simultaneously to the piezoelectric transducer 46. An electrical matching circuit, the design of which is well within the capabilities of those of ordinary skill in the art, may be placed between the receiving coil and the piezo element to improve efficiency, alter the frequency response, or otherwise optimize the system performance.

FIG. 5 is a not-to-scale cross-sectional elevational diagram illustrating an implementation of an implantable microactuator in accordance with the implementation of FIG. 4 in accordance with an exemplary embodiment. In accordance with this exemplary embodiment module 14 is formed with a cylindrical titanium case 54. Titanium is selected due to its favorable biocompatible properties. A first titanium membrane 56 of thickness approximately 10-20 microns is disposed at the end intended to be disposed closet to the wall of the cochlea. A fluid filled chamber 58 is disposed inwardly from membrane 56 and may be filled with a saline solution or distilled water. A second titanium membrane 60 of thickness approximately 30 microns seals chamber 58. A piezoelectric material 62 is disposed on a side of second titanium membrane 60 opposite chamber 58. A radial gap 64 is provided between case 54 and piezoelectric material 62 to minimize interaction between the piezoelectric material and case 54 and allow the titanium membrane 60 to flex under stress. Electrical matching circuit 84 is mounted in a chamber 86 above the piezoelectric material 62 and is electrically coupled to piezoelectric material 62 via line 88, case 56 via line 90 and coil 92 via line 94. “Receiving” coil 92 is wound around magnetic core 96. Titanium case 54 is closed at top end 98 and hermetically sealed.

Using magnetic coupling between two coils, one in the ear canal and one contained in the microactuator assembly, allows both signal and power to be transmitted over the very short distance between them (2-3 mm) with a simple electro-magnetic circuit. A “driver” coil is energized by an audio frequency electrical signal generator, creating a magnetic field that is coupled to the “receiving” coil. The magnetic field in the receiving coil produces a voltage and provides both power and signal simultaneously to the piezoelectric transducer 46. An electrical matching circuit, the design of which is well within the capabilities of those of ordinary skill in the art, may be placed between the receiving coil and the piezo element to improve efficiency, alter the frequency response, or otherwise optimize the system performance.

FIG. 6 is a system block diagram of a partially implantable hearing aid system 100 using light (a form of electromagnetic energy) to transmit audio signals and power to an implanted microactuator in accordance with an exemplary embodiment. In accordance with this exemplary embodiment wearable portion 12 transmits both its power signal and its audio signal using light energy from phototransmitter 102 (such as an LED or Semiconductor LASER) through the air and tympanic membrane (eardrum) of the patient to a photoreceptor 104 (such as a photodiode or other semiconductor device for converting light into electrical energy such as a photovoltaic cell). In module 14 everything is housed in a unitary module with no cables extending from it. Module 14 houses photoreceptor 104 used for receiving a light signal from phototransmitter 102. In this embodiment a simple electrical matching circuit 106 converts a signal received over lines 108 from photoreceptor 104 into a voltage for driving piezoelectric transducer 46. Light signals are single polarity, so there's a significant DC component which can be harvested to power the matching circuit. The signal is carried on the transitions and is detected by an amplifier, processed and used to drive the transducer.

Using a light-based system allows the use of a simple photoelectric circuit. The incoming light signal is generated by the phototransmitter 102 and detected by photoreceptor 104 which is contained within the microactuator assembly. Light easily passes through the thin tympanic membrane and creates a current in the photoreceptor which powers the piezoelectric transducer 46 at audio frequencies. The propagation distance is about 2-3 mm, between light emerging from the phototransmitter 102 and reception at the photoreceptor 104.

FIG. 7 is a not-to-scale cross-sectional elevational diagram illustrating an implementation of an implantable microactuator in accordance with the implementation of FIG. 6 in accordance with an exemplary embodiment. In accordance with this exemplary embodiment module 14 is formed with a cylindrical titanium case 54. Titanium is selected due to its favorable biocompatible properties. A first titanium membrane 56 of thickness approximately 10-20 microns is disposed at the end intended to be disposed closet to the wall of the cochlea. A fluid filled chamber 58 is disposed inwardly from membrane 56 and may be filled with a saline solution or another buffered solution compatible with perilymph. A second titanium membrane 60 of thickness approximately 30 microns seals chamber 58. A piezoelectric material 62 is disposed on a side of the second titanium membrane 60 opposite chamber 58. A radial gap 64 is provided between case 54 and piezoelectric material 62 to minimize interaction between the piezoelectric material and case 54 and allow the titanium membrane 60 to flex under stress. Electrical matching circuit 110 is mounted in a chamber 112 above the piezoelectric material 62 and is electrically coupled to piezoelectric material 62 via line 114. A ceramic insulator 116 with a feedthrough 118 supports photoreceptor 120. Photoreceptor 120 is electrically coupled to circuit 110 via a line (not shown) disposed through feedthrough 118. Titanium case 54 is closed at top end 122 with a relatively optically transparent (at the frequency used by the phototransmitter 102 and photoreceptor 104) and biocompatible encapsulant 124 (such as a biocompatible glass like SCHOTT transponder glass 8625 available from SCHOTT North America of Southbridge, Mass.)

FIG. 8 is a system block diagram of a partially implantable hearing aid system 126 using ultrasonic energy (a form of mechanical energy) to transmit audio signals and power to an implanted microactuator in accordance with an exemplary embodiment. In accordance with this exemplary embodiment wearable portion 12 transmits both its power signal and its audio signal using ultrasonic energy from ultrasonic transmitter 128 through the air and eardrum of the patient to an ultrasonic receiver 130. In module 14 everything is housed in a unitary module with no cables extending from it. Module 14 houses ultrasonic receiver 130 used for receiving an ultrasonic acoustic signal from ultrasonic transmitter 128. In this embodiment a simple electrical matching circuit 132 converts a signal received over line 134 from ultrasonic receiver 130 into a voltage for driving piezoelectric transducer 46 over lines 136. In this case the audio signal modulates an ultrasonic carrier. The carrier does not have a DC component, just AC, so it is used to charge capacitors of both polarities relative to a reference ground, creating positive and negative supply voltages, in addition to the ground. An amplifier operates between the positive and negative supply voltages, senses the audio signal and conditions it to drive the piezo transducer.

Using an ultrasound based system allows the use of high frequency sound (frequencies above the range of human hearing) to carry the power and signal, from which both can be separated and used to drive the piezoelectric transducer 46 at audio frequencies with sufficient power to create the sensation of sound in the cochlea.

FIG. 9 is a not-to-scale cross-sectional elevational diagram illustrating an implementation of an implantable microactuator in accordance with the implementation of FIG. 8 in accordance with an exemplary embodiment. In accordance with this exemplary embodiment module 14 is formed with a cylindrical titanium case 54. Titanium is selected due to its favorable biocompatible properties. A first titanium membrane 56 of thickness approximately 10-20 microns is disposed at the end intended to be disposed closet to the wall of the cochlea. A fluid filled chamber 58 is disposed inwardly from membrane 56 and may be filled with a saline solution or another buffered solution compatible with perilymph. A second titanium membrane 60 of thickness approximately 30 microns seals chamber 58. A piezoelectric material 62 is disposed on a side of second titanium membrane 60 opposite chamber 58. A radial gap 64 is provided between case 54 and piezoelectric material 62 to minimize interaction between the piezoelectric material and case 54 and allow the titanium membrane 60 to flex under stress. Electrical matching circuit 140 is mounted in a chamber 142 above the piezoelectric material 62 and is electrically coupled to piezoelectric material 62 via line 144. A ceramic insulator 146 with a feedthrough 148 supports ultrasonic receiver 150. Ultrasonic receiver 150 is electrically coupled to circuit 140 via a line (not shown) disposed through feedthrough 148. Titanium case 54 is closed at top end 152 with a relatively ultrasonically transparent encapsulant 154.

FIG. 10 is a process flow diagram describing a method 160 of improving patient hearing in accordance with an exemplary embodiment.

Turning to FIG. 10, the method 160 comprises a number of steps which are intended to be performed by software and/or hardware described elsewhere within this disclosure. Various exemplary embodiments may include some or all of the steps hereinafter described. At 162 a hearing impaired patient is provided with a wearable hearing aid electronics package including: a microphone to detect sound in the vicinity of the patient and produce a microphone signal in response thereto; a wireless transmitter circuit responsive to the microphone signal configured to transmit a wireless transducer signal; a power storage device configured to provide power to the transmitter circuit; and a wireless power transmission circuit configured to transmit a wireless power signal.

At 164 an electrically powered microactuator is implanted into a cochlear wall of the patient (or another suitable location). The microactuator includes: a wireless receiver circuit configured to receive the wireless transducer signal; a transducer drive circuit coupled to the wireless receiver circuit and configured to convert the received transducer signal into a transducer drive signal; a transducer coupled to the transducer drive circuit and configured to convert the transducer drive signal into motion; and a wireless power reception circuit configured to receive the wireless power signal and convert the power signal into electrical power for powering the transducer drive circuit.

At 166 sound is detected with the microphone. At 168 a microphone signal is generated in response to the detected sound. At 170 the wireless transducer signal is transmitted with the wireless transmitter circuit. At 172 the wireless transducer signal is received with the wireless receiver circuit. At 174 the transducer is driven with the transducer drive circuit. At 176 the wireless receiver circuit and the transducer circuit are powered with power transmitted wirelessly from the wireless power transmission circuit to the wireless power reception circuit.

As discussed above, it is contemplated that in each exemplary embodiment discussed above, either one transmit/receive system may be used for both the audio signal used to drive the transducer 46 and the electrical power required, or separate systems may be used, if desired. The systems may be mixed, e.g., ultrasonic to provide the audio signal and RF to provide the power, as desired.

While embodiments and applications have been shown and described, it would be apparent to those skilled in the art having the benefit of this disclosure that many more modifications than mentioned above are possible without departing from the inventive concepts disclosed herein. The invention, therefore, is not to be restricted except in the spirit of the appended claims.

What is claimed is:

1. An electrically powered microactuator apparatus configured for implantation into a cochlear wall of a patient, the microactuator comprising:
a wireless receiver circuit configured to receive a wireless transducer signal;
a transducer drive circuit configured to convert the received transducer signal into a transducer drive signal;
a transducer coupled to the transducer drive circuit and configured to convert the transducer drive signal into motion; and
a wireless power reception circuit configured to receive a wireless power signal and convert the power signal into electrical power for powering the transducer drive circuit.

2. The apparatus of claim 1, wherein the wireless power reception circuit includes at least one power storage device configured to power the transducer drive circuit for a period of time in the absence of the wireless power signal.

3. The apparatus of claim 2, wherein the at least one power storage device includes a rechargeable battery.

4. The apparatus of claim 2, wherein the at least one power storage device includes a capacitor.

5. The apparatus of claim 1, wherein the wireless power reception circuit is configured to receive energy wirelessly from a source at a distance from the apparatus.

6. The system of claim 5, wherein the wireless power reception circuit is configured to receive a wireless power signal comprising electromagnetic energy.

7. The system of claim 5, wherein the wireless power reception circuit is configured to receive a wireless power signal comprising magnetic energy.

8. The system of claim 5, wherein the wireless power reception circuit is configured to receive a wireless power signal comprising radio frequency energy.

9. The system of claim 5, wherein the wireless power reception circuit is configured to receive a wireless power signal comprising optical energy.

10. The system of claim 5, wherein the wireless power reception circuit is configured to receive a wireless power signal comprising acoustic energy.

11. A hearing aid system comprising:
a hearing aid electronics package configured to be worn by a patient, the package including:
a microphone to detect sound in the vicinity of the patient and produce a microphone signal in response thereto;
a wireless transmitter circuit responsive to the microphone signal configured to transmit a wireless transducer signal;
a first power storage device configured to provide power to the transmitter circuit;
a wireless power transmission circuit configured to transmit a wireless power signal;
an electrically powered microactuator configured for implantation into a cochlear wall of the patient, the microactuator comprising:
a wireless receiver circuit configured to receive the wireless transducer signal;
a transducer drive circuit configured to convert the received transducer signal into a transducer drive signal;
a transducer coupled to the transducer drive circuit and configured to convert the transducer drive signal into motion; and
a wireless power reception circuit configured to receive the wireless power signal and convert the power signal into electrical power for powering the transducer drive circuit.

12. The system of claim 11, wherein the first power storage device is rechargeable.

13. The system of claim 11, wherein the wireless power reception circuit includes at least one second power storage device configured to power the transducer drive circuit for a period of time in the absence of the wireless power signal.

14. The system of claim 13, wherein the at least one second power storage device includes a rechargeable battery.

15. The system of claim 13, wherein the at least one second power storage device includes a capacitor.

16. The system of claim 11, wherein the package further includes a wireless power transmission circuit configured to wirelessly transmit the wireless power signal to the wireless power reception circuit.

17. The system of claim 16, wherein the wireless power transmission circuit is configured to transmit the wireless power signal using electromagnetic energy.

18. The system of claim 16, wherein the wireless power transmission circuit is configured to transmit the wireless power signal using magnetic energy.

19. The system of claim 16, wherein the wireless power transmission circuit is configured to transmit the wireless power signal using radio frequency energy.

20. The system of claim 16, wherein the wireless power transmission circuit is configured to transmit the wireless power signal using optical energy.

21. The system of claim 16, wherein the wireless power transmission circuit is configured to transmit the wireless power signal using acoustic energy.

22. A hearing aid apparatus configured to be worn by a patient and to wirelessly communicate with an implanted microactuator within the patient, the apparatus comprising:
a microphone configured to detect sound in the vicinity of the patient and produce a microphone signal in response thereto;
a wireless transmitter circuit responsive to the microphone signal, the transmitter circuit configured to transmit a wireless transducer signal to the microactuator; and
a power storage device configured to provide power to the transmitter circuit.

23. The apparatus of claim 22 wherein the power storage device is rechargeable.

24. The apparatus of claim 22, further comprising a wireless power transmission circuit configured to transmit a wireless power signal.

25. The apparatus of claim 22, wherein the wireless power transmission circuit is configured to transmit the wireless power signal using electromagnetic energy.

26. The apparatus of claim 22, wherein the wireless power transmission circuit is configured to transmit the wireless power signal using magnetic energy.

27. The apparatus of claim 22, wherein the wireless power transmission circuit is configured to transmit the wireless power signal using radio frequency energy.

28. The apparatus of claim 22, wherein the wireless power transmission circuit is configured to transmit the wireless power signal using optical energy.

29. The apparatus of claim 22, wherein the wireless power transmission circuit is configured to transmit the wireless power signal using acoustic energy.

30. A method for improving the hearing acuity of a patient comprising:
providing the patient with a wearable hearing aid electronics package including:
a microphone to detect sound in the vicinity of the patient and produce a microphone signal in response thereto;
a wireless transmitter circuit responsive to the microphone signal configured to transmit a wireless transducer signal;
a power storage device configured to provide power to the transmitter circuit; and
a wireless power transmission circuit configured to transmit a wireless power signal;
implanting into a cochlear wall of the patient an electrically powered microactuator, the microactuator including:
a wireless receiver circuit configured to receive the wireless transducer signal;
a transducer drive circuit coupled to the wireless receiver circuit and configured to convert the received transducer signal into a transducer drive signal;
a transducer coupled to the transducer drive circuit and configured to convert the transducer drive signal into motion; and
a wireless power reception circuit configured to receive the wireless power signal and convert the power signal into electrical power for powering the transducer drive circuit;
detecting sound with the microphone;
generating a microphone signal in response to the detected sound;
transmitting the wireless transducer signal with the wireless transmitter circuit;
receiving the wireless transducer signal with the wireless receiver circuit;
driving the transducer with the transducer drive circuit; and
powering the wireless receiver circuit and the transducer circuit with power transmitted wirelessly from the wireless power transmission circuit to the wireless power reception circuit.
